(19) United States
(12) Patent Application Publication
(10) Pub. No.: US 2019/0021458 A1
(43) Pub. Date: Jan. 24, 2019

(54) SMART ORNAMENT CHAIN AND DATA PROCESSING METHOD THEREOF

(71) Applicant: BOE TECHNOLOGY GROUP CO., LTD., Beijing (CN)

(72) Inventors: Enhui GUAN, Beijing (CN); Shuo CHEN, Beijing (CN)

(21) Appl. No.: 15/945,018

(22) Filed: Apr. 4, 2018

(30) Foreign Application Priority Data
Jul. 20, 2017 (CN) 201710616900.2

(51) Int. Cl. A44C 15/00; A44C 5/00; A44C 11/00

(52) U.S. Cl. CPC A44C 15/0015; G06N 99/005; A44C 11/00; A44C 5/00

(57) ABSTRACT

A smart ornament chain and a data processing method are disclosed. The smart ornament chain includes an ornament chain body, and further includes illuminants, a collecting module, a driving module and a processing module arranged in the ornament chain body. The collecting module is configured to collect a current dress color of a user and/or a current ambient brightness. The driving module is configured to drive the illuminants to emit light. The processing module is configured to obtain a color and/or brightness of the ornament chain to be adjusted based on the current dress color and/or the current ambient brightness, and is further configured to control the driving module to perform display based on the color and/or brightness of the ornament chain to be adjusted. The ornament chain can adjust its own color and/or brightness automatically based on the current dress color of the user and/or the current ambient brightness.

### CROSS REFERENCE TO RELATED APPLICATION

The present application claims priority to Chinese Patent Application No. 201710616900.2 filed on Jul. 20, 2017, the entire disclosure of which is incorporated herein by reference.

### TECHNICAL FIELD

This disclosure relates to the technical field of ornament chains, and particularly to a smart ornament chain and a data processing method thereof.

### BACKGROUND

With development of modern society, people's aesthetic consciousness is constantly improving. The jewelry has a unique role in the process of beautifying life. The necklace, the hand chain and the like are all relatively common ornament chains.

Most people, especially women, need to change dresses of different colors and types every day. For the sake of beauty, the ornament chains also need to be changed with the change of the dresses generally, or, even if the dress is not changed, different ornament chains also need to be changed based on differences in ambient brightness, such that a user not only has to purchase a large amount of ornament chains but also has to consume some energy for sorting and collocating.

### SUMMARY

According to one aspect of this disclosure, an embodiment of this disclosure provides a smart ornament chain. The smart ornament chain can comprise: an ornament chain body; illuminants, a collecting module, a driving module and a processing module arranged in the ornament chain body. The collecting module is configured to collect a current dress color of a user and/or a current ambient brightness. The driving module is configured to drive the illuminants to emit light. The processing module is configured to obtain a color and/or brightness of the ornament chain to be adjusted based on the current dress color and/or the current ambient brightness, and to control the driving module to perform display based on the color and/or brightness of the ornament chain to be adjusted.

In one embodiment, the ornament chain body can comprises a chain part for wearing. The collecting module is further configured to collect a pressure value on the chain part. The processing module can be further configured to obtain the pressure value on the chain part, and determine whether the ornament chain is in an operating state based on the pressure value.

In one embodiment, determining whether the ornament chain is in an operating state can comprise determining that the ornament chain is in an operating state if the pressure value is greater than or equal to a preset threshold.

In one embodiment, the illuminants can comprise at least one of: a red light emitting diode, a blue light emitting diode and a green light emitting diode.

In one embodiment, a color of the smart ornament chain can depend on brightnesses of the red light emitting diode, the blue light emitting diode and the green light emitting diode.

In one embodiment, the processing module can comprise: a storage unit for storing a preset correspondence between dress colors and ornament chain colors and a preset correspondence between brightnesses of illuminants and driving signals; and/or a preset correspondence between ambient brightnesses and ornament chain brightnesses and a preset correspondence between ornament chain brightnesses and driving signals.

The processing module can further comprise: an obtaining unit for obtaining a current dress color of a user and/or a current ambient brightness, and a processing unit for obtaining a color of the ornament chain to be adjusted based on the current dress color and the preset correspondence between the dress colors and the ornament chain colors, obtaining brightnesses corresponding to different types of illuminants based on the color of the ornament chain to be adjusted, and obtaining driving signals corresponding to different types of illuminants based on the brightnesses corresponding to different types of illuminants and the preset correspondence between the brightnesses of the illuminants and the driving signals, so as to send the driving signals to the driving module for triggering the driving module to output driving currents, and/or for obtaining a brightness of the ornament chain to be adjusted based on the current ambient brightness and the preset correspondence between ambient brightnesses and ornament chain brightnesses, obtaining driving signals corresponding to different types of illuminants based on the brightness of the ornament chain to be adjusted and the preset correspondence between the ornament chain brightnesses and the driving signals, so as to send the driving signals to the driving module for triggering the driving module to output driving currents.

In one embodiment, the processing module can be further configured to obtain output currents fed back by the driving module, and to obtain current parameters corresponding to driving circuits in the driving module based on the output currents fed back by the driving module, so as to adjust the output currents of the driving circuits in the driving module through the current parameters.

According to another aspect of embodiments of this disclosure, it is provided a data processing method of a smart ornament chain. The data processing method can comprise: obtaining a current dress color of a user and/or a current ambient brightness, obtaining a color and/or brightness of the ornament chain to be adjusted based on the current dress color and/or the current ambient brightness, and controlling a driving module to perform display based on the color and/or brightness of the ornament chain to be adjusted.

In one embodiment, the ornament chain can comprise an ornament chain body, and the ornament chain body comprises a chain part for wearing. Before obtaining a current dress color of a user and/or a current ambient brightness, the method can further comprise: obtaining a pressure value on the chain part, and determining whether the ornament chain is in an operating state based on the pressure value, wherein determining whether the ornament chain is in an operating state comprises determining that the ornament chain is in an operating state if the pressure value is greater than or equal to a preset threshold.

In one embodiment, obtaining a color of the ornament chain to be adjusted based on the current dress color can comprise: obtaining a color of the ornament chain to be adjusted based on the current dress color and a preset correspondence between dress colors and ornament chain colors.

In one embodiment, controlling a driving module to perform display based on the color of the ornament chain to be adjusted can comprise: obtaining brightnesses corresponding to different types of illuminants based on the color of the ornament chain to be adjusted, obtaining driving signals corresponding to different types of illuminants based on the brightnesses corresponding to different types of illuminants and a preset correspondence between brightnesses of the illuminants and driving signals, and sending the driving signals to the driving module for triggering the driving module to output driving currents.

In one embodiment, obtaining a brightness of the ornament chain to be adjusted based on the current ambient brightness can comprise: obtaining a brightness of the ornament chain to be adjusted based on the current ambient brightness and a preset correspondence between ambient brightnesses and ornament chain brightnesses.

In one embodiment, controlling the driving module to perform display based on the brightness of the ornament chain to be adjusted can comprise: obtaining driving signals corresponding to different types of illuminants based on the brightness of the ornament chain to be adjusted and a preset correspondence between ornament chain brightnesses and driving signals, and sending the driving signals to the driving module for triggering the driving module to output driving currents.

In one embodiment, the data processing method can further comprise: obtaining current parameters corresponding to driving circuits in the driving module based on output currents fed back by the driving module, so as to adjust output currents of the driving circuits in the driving module through the current parameters.

Of course, any product or method implementing this disclosure does not necessarily have to achieve all advantages stated above simultaneously. Other features and advantages of this disclosure will be set out in the subsequent embodiments of the description, and will be evident partially from the embodiments of the description or will be understood by implementing this disclosure. The objects and other advantages of the embodiments of this disclosure can be achieved and obtained from the structures particularly pointed out in the description, the Claims and the drawings.

### BRIEF DESCRIPTION OF THE DRAWINGS

The drawings are used for providing further understanding to the technical solutions of this disclosure and constitute a part of the description. They are used for explaining the technical solutions of this disclosure together with the embodiments of the present application and do not constitute limitations to the technical solutions of this disclosure.

FIG. 1 is a structural schematic diagram of a smart ornament chain provided by an embodiment of this disclosure;

FIG. 2 is another structural schematic diagram of a smart ornament chain provided by an embodiment of this disclosure;

FIG. 3 is a color reference table provided by an embodiment of this disclosure;

FIG. 4 is a schematic diagram of a correspondence between ambient brightnesses and ornament chain brightnesses provided by an embodiment of this disclosure;

FIG. 5 is a schematic diagram of adjustment of an output current provided by an embodiment of this disclosure;

FIG. 6 is a schematic diagram of output currents adjusted via current parameters and outputted by a driving module provided by an embodiment of this disclosure;

FIG. 7 is a flow chart of a data processing method of a smart ornament chain provided by an embodiment of this disclosure;

FIG. 8 is a flow chart of a data processing method of a smart ornament chain provided by another embodiment of this disclosure;

FIG. 9 is a flow chart of a method for controlling a driving module to perform display based on a color of an ornament chain to be adjusted provided by an embodiment of this disclosure; and

FIG. 10 is a flow chart of a method for controlling a driving module to perform display based on a brightness of an ornament chain to be adjusted provided by another embodiment of this disclosure.

### EMBODIMENTS

In order to enable the objects, the technical solutions and the advantages of this disclosure to be more explicit, the embodiments of this disclosure will be explained below in detail in conjunction with the drawings. It should be noted that in the case of not conflicting, the embodiments in the disclosure and the features in the embodiments can be combined with each other arbitrarily.

The steps shown in the flow chart of the drawings can be performed in a computer system such as a set of computer-executable instructions. Although the logical order has been shown in the flow chart, in some cases, the steps as shown or described can be performed in an order different from that herein.

FIG. 1 is a structural schematic diagram of a smart ornament chain provided by an embodiment of this disclosure. As shown in FIG. 1, the smart ornament chain provided by an embodiment of this disclosure can comprise: an ornament chain body 10, illuminants 50, a collecting module 20, a processing module 30 and a driving module 40 arranged in the ornament chain body 10.

The collecting module 20 is configured to collect a current dress color of a user and/or a current ambient brightness. The processing module 30 is configured to obtain a color and/or brightness of the ornament chain to be adjusted based on the current dress color and/or the current ambient brightness, and is further configured to control the driving module to perform display based on the color and/or brightness of the ornament chain to be adjusted. The driving module 40 is configured to drive the illuminants 50 to emit light.

The collecting module 20 can comprise: a color sensor and a light sensor. It should be realized that the collecting module 20 can further comprise other devices that can collect the current dress color of the user and/or the current ambient brightness. It will not be defined in this disclosure.

The illuminants 50 can be light emitting diodes (LEDs) etc., which will not be defined in this disclosure. In one embodiment of this disclosure, the ornament chain body 10 can comprise a plurality of light emitting diodes.

The processing module 30 can be a microprocessor that can perform pulse width modulation. It will not be defined in this disclosure.

The driving module 40 can comprise driving circuits, which control the illuminants 50 to emit light by inputting driving currents to the illuminants 50. It should be realized that the driving module 40 can comprises many types of driving circuits. Different types of driving circuits correspond to different types of illuminants.

The smart ornament chain provided by an embodiment of this disclosure comprises: illuminants, a collecting module, a driving module and a processing module arranged in the ornament chain body. The collecting module is configured to collect a current dress color of a user and/or a current ambient brightness. The processing module is configured to obtain a color and/or brightness of the ornament chain to be adjusted based on the current dress color and/or the current ambient brightness, and is further configured to control the driving module to perform display based on the color and/or brightness of the ornament chain to be adjusted. The driving module is configured to drive the illuminants to emit light. The ornament chain provided by an embodiment of this disclosure can automatically adjust its own color and/or brightness based on the current dress color of the user and/or the current ambient brightness, which improves applicability of the ornament chain.

In one embodiment of this disclosure, as shown in FIG. 1, the ornament chain body 10 can comprise: a chain part 11 for wearing. In such a case, the collecting module 20 can be further configured to collect a pressure value on the chain part 11. The processing module 30 can be further configured to obtain the pressure value on the chain part 11 and determine whether the ornament chain is in an operating state based on the pressure value.

The collecting module 20 can be a pressure sensor or other devices that can collect pressure. The pressure sensor can be arranged at the end of the chain part, and can be arranged at a joint of the chain part and a pendant 12 hanging on the chain part, or can also be arranged at other positions of the chain part. It will not be defined in this disclosure.

In one embodiment of this disclosure, the processing module 30 can determine whether the user is wearing the ornament chain based on the pressure value. If the pressure value is greater than or equal to a preset threshold, the processing module 30 determines that the ornament chain is in an operating state, i.e., the user is wearing the ornament chain. If the pressure value is less than the preset threshold, the processing module 30 determines that the ornament chain is in a standby state, i.e., the user is not wearing the ornament chain.

It should be noted that the preset threshold can refer to a pressure value collected by the collecting module when the ornament chain is placed horizontally. At this time, the pressure value collected by the collecting module is relatively small. When the user is wearing the ornament chain, i.e., the ornament chain is almost in a vertical state, the pressure value collected by the collecting module generally also includes a gravity of the pendant, and thus it is far greater than the preset threshold.

According to this disclosure, the standby state of the ornament chain refers to a state in which an ornament chain is not worn by a user. When the processing module detects that a user is not wearing the ornament chain, the collecting module is not triggered to collect the current dress color and/or the current ambient brightness, and the processing module does not adjust the color and the brightness of the ornament chain either. Thus, the ornament chain can be in a low power consumption power saving mode.

In one embodiment of this disclosure, the ornament chain can comprise multiple types of illuminants, e.g., red light emitting diodes, blue light emitting diodes and green light emitting diodes.

The numbers of the red light emitting diodes, the blue light emitting diodes and the green light emitting diodes in the ornament chain can be either the same or different. This depends on the requirement of the ornament chain. In one embodiment of this disclosure, the red light emitting diodes, the blue light emitting diodes or the green light emitting diodes can be arranged in a pendant connected with a chain part. They can be distributed in the pendant uniformly or nonuniformly. This depends on actual requirements. It will not be defined in this disclosure specifically.

In one embodiment of this disclosure, a color of a smart ornament chain depends on brightnesses of a red light emitting diode, a blue light emitting diode and a green light emitting diode. When the color of the smart ornament chain needs to be adjusted, it only needs to adjust the brightnesses of the red light emitting diode, the blue light emitting diode and the green light emitting diode. Assuming that the brightnesses of the red light emitting diode, the blue light emitting diode and the green light emitting diode are X, Y, Z respectively, the color C of the ornament chain is determined by X, Y and Z, i.e., the color parameter C=ƒ(X, Y, Z), wherein the function ƒ uses the function expression commonly used in the art for determining a color.

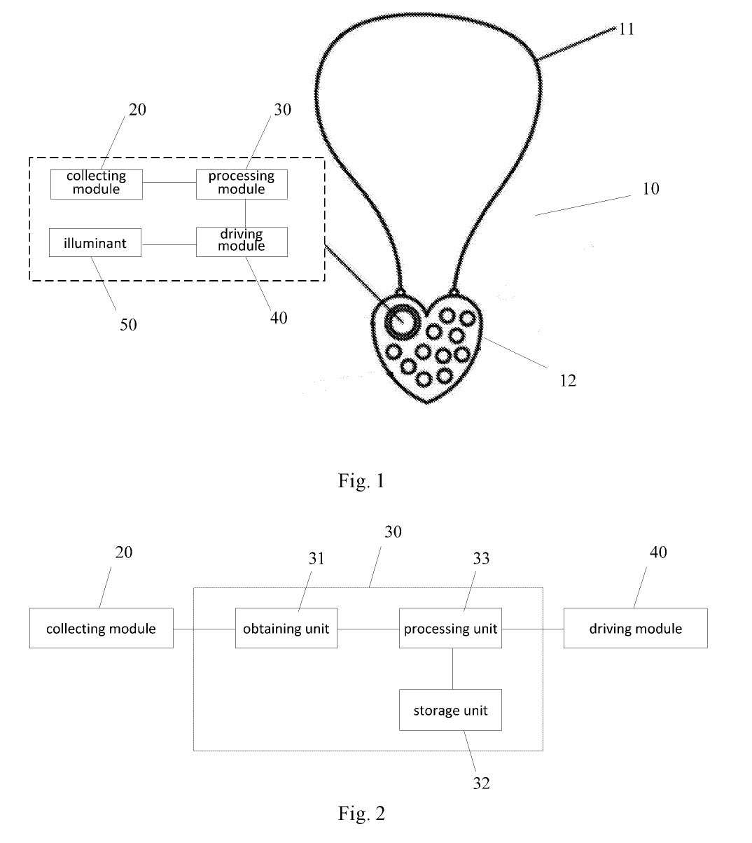

FIG. 2 is a structural schematic diagram of a smart ornament chain provided by another embodiment of this disclosure. As shown in FIG. 2, the processing module 30 can further comprise: an obtaining unit 31, a storage unit 32 and a processing unit 33.

The obtaining unit 31 is configured to obtain the current dress color of the user and/or the current ambient brightness. In one embodiment, the obtaining unit 31 obtains the current dress color of the user and/or the current ambient brightness from the collecting module 20.

The storage unit 32 is configured to store a preset correspondence between dress colors and ornament chain colors and a preset correspondence between illuminant brightnesses and driving signals, and/or a preset correspondence between ambient brightnesses and ornament chain brightnesses and a preset correspondence between ornament chain brightnesses and driving signals.

The preset correspondence between the dress colors and the ornament chain colors has been transmitted to the ornament chain by a terminal before a user uses the ornament chain. In one embodiment, the user installs an application in a terminal for learning the user's preference on color collocation. When applying the application, the user will be asked what color matches with a color appeared in a screen best. After the user selects the most matching color from a color reference table in the application, the application will record the answer. After a large amount of data is collected, the application will analyze the recorded information and obtain a correspondence between dress colors and ornament chain colors, and then transmit it to the ornament chain in a way of data transmission.

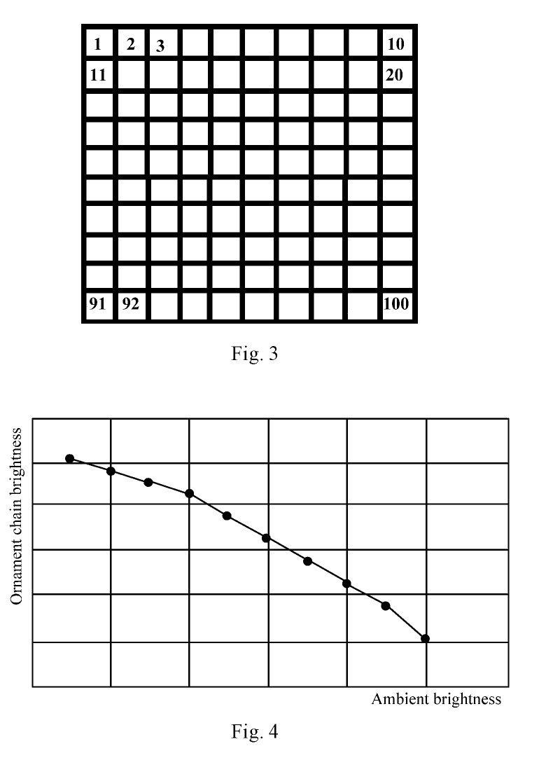

FIG. 3 is a color reference table provided by an embodiment of this disclosure. As shown in FIG. 3, there are hundreds of colors in the application of the terminal. According to gradual transformation of colors, for example one hundred colors can be set. As shown in FIG. 3, digits 1-100 represent 100 colors. Generally, as shown in FIG. 3, colors in the color reference table deepen gradually from left to right or from up to bottom. Explanation will be made below by taking a row as an example. As shown in FIG. 3, assuming that the first row represents grey, 1 represents white, 2 represents light grey, the grey of 3 is deeper than the grey of 2, and by analogy, the grey of 10 is the deepest. That is to say, the grey deepens gradually from 1 to 10. Also as shown in FIG. 3, assuming that the second row represents orange, the orange deepens gradually from 11 to 20. Of course, the color reference table can also include more colors. This can be determined based on requirement of the user, and this disclosure is not limited to this.

In an embodiment of this disclosure, the preset correspondence between the illuminant brightnesses and the driving signals, the preset correspondence between the ornament chain brightnesses and the driving signals or the preset correspondence between the ambient brightnesses and the ornament chain brightnesses can be determined according to common expressions in the art.

FIG. 4 is a schematic diagram of a correspondence between ambient brightnesses and ornament chain brightnesses provided by an embodiment of this disclosure. As shown in FIG. 4, the ambient brightness is inversely proportional to the ornament chain brightness, i.e., the larger the ambient brightness is, the smaller the ornament chain brightness will be, and the smaller the ambient brightness is, the larger the ornament chain brightness will be. It should be realized that when the ambient brightness is relatively large, an excellent contrast effect will be formed if the color of the ornament chain is a little bit dark, which provides an elegant and cool feeling to people. When the ambient is relatively dark and the brightness is relatively low, the ornament chain brightness will be relatively large, which provides a warm and pleasant feeling to people.

Return to FIG. 2, the processing unit 33 can be configured to obtain the color of the ornament chain to be adjusted based on the current dress color and the preset correspondence between the dress colors and the ornament chain colors, obtain brightnesses corresponding to different types of illuminants based on the color of the ornament chain to be adjusted, and obtain driving signals corresponding to different types of illuminants based on the brightnesses corresponding to the different types of illuminants and the preset correspondence between the illuminant brightnesses and the driving signals, so as to send the driving signals to the driving module for triggering the driving module to output driving currents. According to this disclosure, in the event that the ornament chain comprises multiple types of illuminants (e.g., three types of light emitting diodes of red light emitting diodes, blue light emitting diodes and green light emitting diodes), the processing unit 33 can obtain a brightness corresponding to each type of illuminants based on the color of the ornament chain to be adjusted, and then obtain a driving signal corresponding to each type of illuminants based on the preset correspondence between the illuminant brightnesses and the driving signals (for example in which it is classified according to types of illuminants). The processing unit 33 can also be configured to obtain a brightness of the ornament chain to be adjusted based on the current ambient brightness and the preset correspondence between the ambient brightnesses and the ornament chain brightnesses, obtain driving signals corresponding to different types of illuminants based on the brightness of the ornament chain to be adjusted and the preset correspondence between the ornament chain brightnesses and the driving signals, and send the driving signals to the driving module for triggering the driving module to output driving currents. According to this disclosure, in the event that the ornament chain comprises multiple types of illuminants, the brightness of the ornament chain can include a brightnesses corresponding to each type of illuminants.

In one embodiment, the driving signal emitted by the processing unit 33 is a pulse width modulation (PMW) signal.

The brightness of the ornament chain is determined by the driving current inputted by the driving module to the illuminants. That is, the brightness of the ornament chain satisfies a formula F_{brightness}=ƒ(I), wherein I is the driving current, f is a function determined as needed.

According to this disclosure, the driving module outputs a driving current to an illuminant based on a driving signal. The driving module can include multiple types of driving circuits, and different types of driving circuits control different types of illuminants. Hence, the processing unit 33 obtains driving signals corresponding to different types of illuminants and sends the driving signals corresponding to different types of illuminants to driving circuits corresponding to different types of illuminants. That is to say, the driving module actually can send multiple driving signals to drive different types of illuminants.

In an embodiment of this disclosure, the ornament chain body or a space of the pendant therein can be divided into a plurality of different regions. The number of the divided regions can be 3, or 6, or 9, which will not be defined in this disclosure. Each region can include one or more types of illuminants.

In order to control the illuminants better, a type of driving circuits can be arranged for each type of illuminants. For each region, a corresponding driving circuit can be configured for each type of illuminants. For example, if the space of the pendant or the ornament chain body is divided into six regions, and each region includes three types of illuminants (e.g., a red light emitting diode, a blue light emitting diode and a green light emitting diode), the driving module can include three types of driving circuits, the number of each type of driving circuits is six, which are allocated to the six regions respectively, for driving the corresponding type of illuminants in the driving circuit.

In practice, there may be inevitably some differences between driving circuits of the same type in the driving module. Hence, even if the same driving signal is received, the driving currents outputted by the driving circuits of the same type are actually different, thereby enabling the brightnesses of the illuminants of the same type in different regions to be nonuniform. In order to ensure uniform brightness of each illuminant of the same type of the smart ornament chain, the obtaining unit 31 in an embodiment of this disclosure is further configured to obtain output currents fed back by driving circuits in the driving module 40. In such a case, the processing unit 33 is further configured to: obtain corresponding current parameters Datas of driving circuits in the driving module based on the output currents fed back by the driving module, so as to adjust the output currents of the driving module through the current parameters, thereby ensuring uniform brightness of each illuminant of the same type.

In an embodiment of this disclosure, it is assumed that each driving circuit corresponds to a current parameter. The current parameters of the driving circuits can be the same and can also be different, which can be determined based on the output currents of the driving circuits. In the process of obtaining current parameters corresponding to driving circuits, in order to ensure that currents finally outputted by the driving circuits of the same type are consistent, any of these currents can be selected as a standard current (for example, a current parameter Data corresponding to the driving circuit which is selected as the standard current is set to be equal to 1), so as to determine current parameters of other driving circuits based on the standard current. The processing unit 33 can appropriately adjust the other driving circuits of the same type based on the determined current parameters, so as to enable the currents outputted by all driving circuits of the same type to be equal to the standard current for the driving circuits of this type, thereby enabling the brightnesses of the illuminants of the same type in the regions to be uniform. The current parameters of the other driving circuits can be determined in various well-known manners.

In one embodiment, the processing unit 33 adjusts an output current of a corresponding driving circuit in the driving module through the determined current parameter. Particularly, the processing unit controls a resistance of the driving circuit in the driving module through an inter-integrated circuit (I²C), so as to adjust the output current of the driving circuit, thereby ensuring that a brightness of each illuminant of the same type to be uniform. I²C is equivalent to an adjustable resistance in function.

The embodiment of this disclosure adjusts the driving circuits in the driving module by obtaining current parameters corresponding to the driving circuits in the driving module, so as to avoid the problem that the ornament chain cannot achieve uniform brightness in different regions due to a difference between performances of the driving circuits.

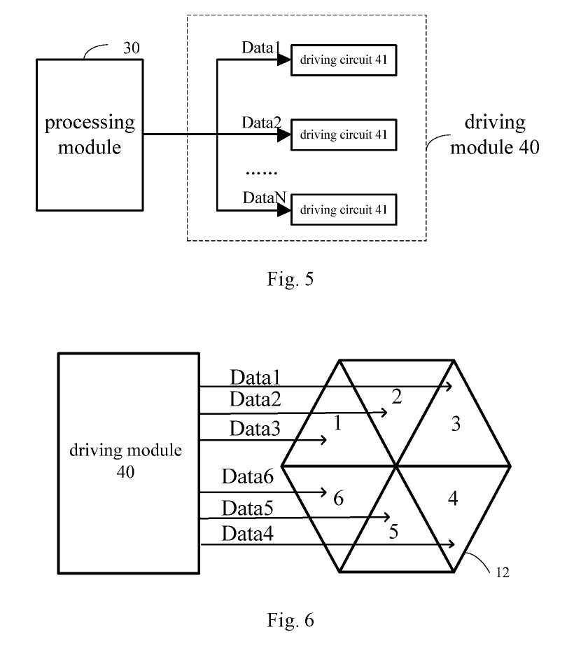

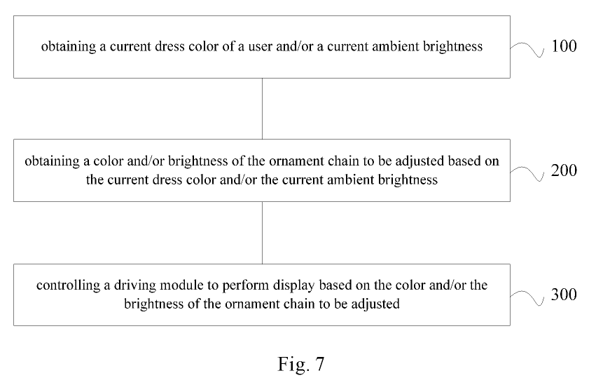

FIG. 5 is a schematic diagram of adjustment of an output current provided by an embodiment of this disclosure. FIG. 6 is a schematic diagram of output currents adjusted via current parameters and outputted by a driving module provided by an embodiment of this disclosure. As shown in FIG. 5, the processing module 30 sends corresponding multiple types of driving signals to the driving module 40 comprising multiple types of driving circuits 41, and one type of driving circuits correspond to one type of driving signals. Each driving circuit 41 in the driving module 40 feeds back an output current to the processing module 30. The processing module 30 determines based on the output current a current parameter for each driving circuit in the driving module. As shown in FIG. 5, Data1, Data2, . . . , DataN are current parameters of N corresponding driving circuits respectively. Further, the processing module 30 adjusts respective driving circuits based on the current parameters so as to enable the driving circuits of the same type to output the same driving circuit. An output current of any driving circuit can be taken as a standard driving current, so as to adjust output currents of other driving circuits of the same type based on the standard driving current.

FIG. 6 is a schematic diagram of output currents adjusted via current parameters and outputted by a driving module provided by an embodiment of this disclosure. In the embodiment as shown in FIG. 6, the space of the pendant 12 is divided into six regions, each region only including one type of illuminants. Thus, the driving module 40 comprises one corresponding driving circuit for each region, to drive illuminants in this region to emit light. As shown in FIG. 6, the driving circuit corresponding to parameter Data1 provides a driving current for region 3, the driving circuit corresponding to parameter Data2 provides a driving current for region 2, the driving circuit corresponding to parameter Data3 provides a driving current for region 1, the driving circuit corresponding to parameter Data6 provides a driving current for region 6, the driving circuit corresponding to parameter Data5 provides a driving current for region 5, and the driving circuit corresponding to parameter Data4 provides a driving current for region 4. It should be noted that in this embodiment, the space of the pendant can also be divided into a plurality of other regions, such as 3 or 9. This disclosure will not be limited to this.

The working principle of the smart ornament chain provided by an embodiment of this disclosure will be explained specifically below in conjunction with the above description. As shown in FIGS. 1 and 2, the pressure sensor arranged in the collecting module 20 collects a pressure value on the chain part 11. The processing unit 33 determines whether the ornament chain 10 is in an operating state based on the pressure value. If the pressure value is greater than or equal to a preset threshold, it is determined that the ornament chain 10 is in the operating state. If the ornament chain 10 is in the operating state, the light sensor arranged in the collecting module 20 collects the current ambient brightness, and the color sensor arranged in the collecting module 20 collects the current dress color of the user. In one embodiment, the obtaining unit 31 obtains the current dress color of the user. The processing unit 33 obtains the color of the ornament chain to be adjusted based on the current dress color and the preset correspondence between the dress colors and the ornament chain colors, obtain brightnesses corresponding to different types of illuminants based on the color of the ornament chain to be adjusted, and obtains driving signals corresponding to different types of illuminants based on the brightnesses corresponding to the different types of illuminants and the preset correspondence between the illuminant brightnesses and the driving signals, and send the driving signals to the driving module. In one embodiment, the obtaining unit 31 obtains the current ambient brightness. The processing unit 33 obtains a brightness of the ornament chain to be adjusted based on the current ambient brightness and the preset correspondence between the ambient brightnesses and the ornament chain brightnesses, obtains driving signals corresponding to different types of illuminants based on the brightness of the ornament chain to be adjusted and the preset correspondence between the ornament chain brightnesses and the driving signals, and sends the driving signals to the driving module. The driving module outputs driving currents based on the driving signals so as to drive the illuminants to emit light, thereby implementing adjustment of the color and the brightness of the ornament chain.

Based on the inventive concept of the above embodiment, an embodiment of this disclosure provides a data processing method of a smart ornament chain. FIG. 7 is a schematic flow chart of a data processing method of a smart ornament chain provided by an embodiment of this disclosure. As shown in FIG. 7, the data processing method of a smart ornament chain provided by an embodiment of this disclosure can comprise:

Step 100, obtaining a current dress color of a user and/or a current ambient brightness.

In one embodiment, the current dress color of the user is collected by a color sensor arranged on the ornament chain body, and the current ambient brightness is collected by a light sensor arranged on the ornament chain body.

As shown in FIG. 7, the data processing method of the smart ornament chain provided by an embodiment of this disclosure can further comprise: step 200, obtaining a color and/or brightness of the ornament chain to be adjusted based on the current dress color and/or the current ambient brightness.

In one embodiment, the ambient brightness is inversely proportional to the ornament chain brightness, i.e., the larger the ambient brightness is, the smaller the ornament chain brightness will be, and the smaller the ambient brightness is, the larger the ornament chain brightness will be. It should be realized that when the ambient brightness is relatively large, an excellent contrast effect will be formed if the color of the ornament chain is a little bit dark, which provides an elegant and cool feeling to people. When the ambient is relatively dark and the brightness is relatively low, the brightness of the ornament chain will be relatively large, which provides a warm and pleasant feeling to people.

In one embodiment, the correspondences between the current dress colors and the colors of the ornament chain to be adjusted differ due to different users.

As shown in FIG. 7, the data processing method of a smart ornament chain provided by an embodiment of this disclosure can further comprise: step 300, controlling a driving module to perform display based on the color and/or the brightness of the ornament chain to be adjusted.

As stated above, the data processing method of the smart ornament chain provided by an embodiment of this disclosure can comprise: obtaining a current dress color of a user and/or a current ambient brightness, obtaining a color and/or brightness of the ornament chain to be adjusted based on the current dress color and/or the current ambient brightness, and controlling a driving module to perform display based on the color and/or the brightness of the ornament chain to the adjusted. The technical solution provided by the embodiment of this disclosure can adjust its own color and/or brightness automatically based on the current dress color of the user and/or the current ambient brightness, which improves applicability of the ornament chain.

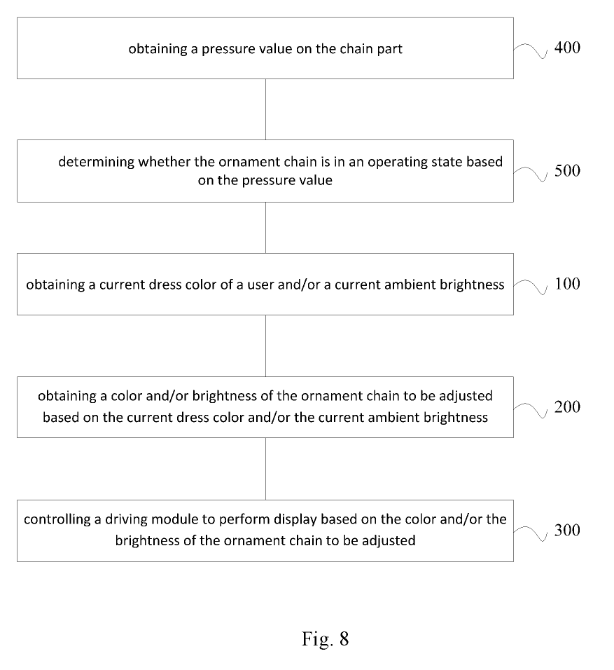

FIG. 8 is a schematic flow chart of a data processing method of a smart ornament chain provided by another embodiment of this disclosure. In an embodiment according to this disclosure, the ornament chain can comprise an ornament chain body. The ornament chain body can comprise: a chain part for wearing. As shown in FIG. 8, in addition to the steps (e.g., step 100, step 200, step 300) in the data processing method as shown in FIG. 7, the data processing method can further comprise: before the step 100,

Step 400, obtaining a pressure value on the chain part,

Step 500, determining whether the ornament chain is in an operating state based on the pressure value.

According to an embodiment of this disclosure, in step 500, if it is determined that the ornament chain is in the operating state, step 100 will be performed.

In one embodiment, if the pressure value is greater than or equal to a preset threshold, it is determined that the ornament chain is in an operating state, otherwise, it is determined that the ornament chain is not in the operating state. When the ornament chain is not in the operating state, the ornament chain is set in a standby mode of low power consumption and power saving.

In one embodiment, step 200 can further comprise: obtaining a color of the ornament chain to be adjusted based on the current dress color and the preset correspondence between dress colors and ornament chain colors.

In this embodiment, the preset correspondence between the dress colors and the ornament chain colors is transmitted to the ornament chain by a terminal before a user uses the ornament chain. The user installs an application in the terminal for learning the user's preference on color collocation. When applying the application, the user will be asked what color matches with a color appeared in a screen best. After the user selects the most matching color from a color reference table in the application, the application will record the answer. After a large amount of data is collected, the application can analyze and obtain a correspondence between dress colors of the user and ornament chain colors, and then transmit it to the ornament chain in a way of data transmission.

In this embodiment, the smart ornament chain can comprise multiple types of illuminants, e.g., red light emitting diodes, blue light emitting diodes and green light emitting diodes.

The numbers of the red light emitting diodes, the blue light emitting diodes and the green light emitting diodes can be plural, which can be either the same or different. This depends on the requirements of different ornament chains. In addition, the red light emitting diodes, the blue light emitting diodes and the green light emitting diodes are arranged in a pendant connected with the chain part. They can be distributed uniformly or nonuniformly. This can be determined depends on the actual requirements. It is not defined in this disclosure specifically.

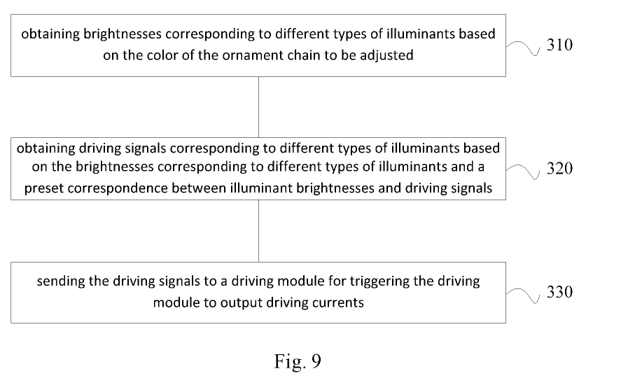

FIG. 9 is a flow chart of a method (i.e., step 300 as shown in FIG. 7 or 8) for controlling the driving module to perform display based on the color of the ornament chain to be adjusted, provided by an embodiment of this disclosure. As shown in FIG. 9, the method can comprise:

Step 310, obtaining brightnesses corresponding to different types of illuminants based on the color of the ornament chain to be adjusted.

In this embodiment, the color of the smart ornament chain depends on the brightnesses of the red light emitting diode, the blue light emitting diode and the green light emitting diode. When the color of the smart ornament chain needs to be adjusted, it only needs to adjust the brightnesses of the red light emitting diode, the blue light emitting diode and the green light emitting diode. Assuming that the brightnesses of the red light emitting diode, the blue light emitting diode and the green light emitting diode are X, Y, Z respectively, the color C of the ornament chain is determined by X, Y and Z, i.e., the color parameter C=ƒ(X, Y, Z), wherein the function ƒ uses the function expression commonly used in the art.

As shown in FIG. 9, the method can further comprise: step 320, obtaining driving signals corresponding to different types of illuminants based on the brightnesses corresponding to different types of illuminants and the preset correspondence between illuminant brightnesses and driving signals.

The driving signals corresponding to different types of illuminants can be either the same or different, which can be determined based on the color of the ornament chain to be adjusted.

As shown in FIG. 9, the method can further comprise: step 330, sending the driving signals to the driving module for triggering the driving module to output driving currents.

The driving module can comprise multiple types of driving circuits, and each type of driving circuit can drive one corresponding type of illuminants.

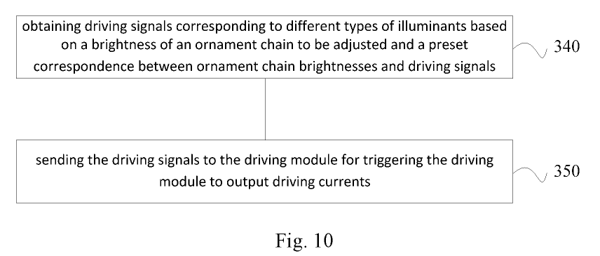

FIG. 10 is a flow chart of a method (i.e., step 300 as shown in FIG. 7 or 8) for controlling a driving module to perform display based on the brightness of the ornament chain to be adjusted, provided by another embodiment of this disclosure. As shown in FIG. 10, the method can comprise:

Step 340, obtaining driving signals corresponding to different types of illuminants based on the brightness of the ornament chain to be adjusted and the preset correspondence between ornament chain brightnesses and driving signals.

Step 350, sending the driving signals to a driving module for triggering the driving module to output driving currents.

In one embodiment, after step 350, the method can further comprise: obtaining output currents fed back by the driving module, and obtaining current parameters based on the driving signals and the output currents fed back by the driving module, so as to adjust the output currents of the driving module through the current parameters, thereby ensuring that the brightness of each illuminant of the same type to be uniform.

Although the embodiments disclosed by this disclosure have been described above, the contents are embodiments merely used for conveniently understanding this disclosure, rather than limiting this disclosure. Any skilled person in the art, on the premise of not departing from the spirit and the scope disclosed by this disclosure, can make any amendment and modification in forms and details of the embodiments. However, the patent protection scope of this disclosure still must be defined by the attached Claims.

1. A smart ornament chain, comprising: an ornament chain body, illuminants, a collecting module, a driving module and a processing module arranged in the ornament chain body; and wherein,
the collecting module is configured to collect a current dress color of a user or a current ambient brightness;
the driving module is configured to drive the illuminants to emit light; and
the processing module is configured to obtain a color or brightness of the ornament chain to be adjusted based on the current dress color or the current ambient brightness; and to control the driving module to perform display based on the color or brightness of the ornament chain to be adjusted.

2. The smart ornament chain according to claim 1, wherein the ornament chain body comprises a chain part for wearing; and wherein,
the collecting module is further configured to collect a pressure value on the chain part; the processing module is further configured to obtain the pressure value on the chain part, and determine whether the ornament chain is in an operating state based on the pressure value.

3. The smart ornament chain according to claim 2, wherein determining whether the ornament chain is in an operating state comprises determining that the ornament chain is in an operating state if the pressure value is greater than or equal to a preset threshold.

4. The smart ornament chain according to claim 1, wherein the illuminants comprise at least one of: a red light emitting diode, a blue light emitting diode and a green light emitting diode.

5. The smart ornament chain according to claim 4, wherein a color of the smart ornament chain depends on brightnesses of the red light emitting diode, the blue light emitting diode and the green light emitting diode.

6. The smart ornament chain according to claim 1, wherein the processing module comprises: a storage unit for storing a preset correspondence between dress colors and ornament chain colors and a preset correspondence between brightnesses of illuminants and driving signals; or a preset correspondence between ambient brightnesses and ornament chain brightnesses and a preset correspondence between ornament chain brightnesses and driving signals.

7. The smart ornament chain according to claim 6, wherein the processing module further comprises:
an obtaining unit for obtaining a current dress color of a user or a current ambient brightness;
a processing unit for obtaining a color of the ornament chain to be adjusted based on the current dress color and the preset correspondence between the dress colors and the ornament chain colors; obtaining brightnesses corresponding to different types of illuminants based on the color of the ornament chain to be adjusted, and obtaining driving signals corresponding to different types of illuminants based on the brightnesses corresponding to different types of illuminants and the preset correspondence between the brightnesses of the illuminants and the driving signals, so as to send the driving signals to the driving module for triggering the driving module to output driving currents; or for obtaining a brightness of the ornament chain to be adjusted based on the current ambient brightness and the preset correspondence between the ambient brightness and the ornament chain brightness; obtaining driving signals corresponding to different types of illuminants based on the brightness of the ornament chain to be adjusted and the preset correspondence between the ornament chain brightnesses and the driving signals, so as to send the driving signals to the driving module for triggering the driving module to output driving currents.

8. The smart ornament chain according to claim 1, wherein the processing module is further configured to: obtain output currents fed back by the driving module; to obtain current parameters corresponding to driving circuits in the driving module based on the output currents fed back by the driving module, so as to adjust the output currents of the driving circuits in the driving module through the current parameters.

9. A method for data processing of a smart ornament chain, comprising:
obtaining a current dress color of a user or a current ambient brightness;
obtaining a color or brightness of the ornament chain to be adjusted based on the current dress color or the current ambient brightness; and
controlling a driving module to perform display based on the color or brightness of the ornament chain to be adjusted.

10. The method according to claim 9, wherein the ornament chain comprises an ornament chain body, and the ornament chain body comprises a chain part for wearing; and wherein,
before obtaining a current dress color of a user or a current ambient brightness, the method further comprises:
obtaining a pressure value on the chain part; and
determining whether the ornament chain is in an operating state based on the pressure value, and wherein determining whether the ornament chain is in an operating state comprises determining that the ornament chain is in an operating state if the pressure value is greater than or equal to a preset threshold.

11. The method according to claim 9, wherein obtaining a color of the ornament chain to be adjusted based on the current dress color comprises:
obtaining a color of the ornament chain to be adjusted based on the current dress color and a preset correspondence between dress colors and ornament chain colors.

12. The method according to claim 11, wherein controlling the driving module to perform display based on the color of the ornament chain to be adjusted comprises:
obtaining brightnesses corresponding to different types of illuminants based on the color of the ornament chain to be adjusted;
obtaining driving signals corresponding to different types of illuminants based on the brightnesses corresponding to different types of illuminants and a preset correspondence between brightnesses of illuminants and driving signals; and
sending the driving signals to the driving module for triggering the driving module to output driving currents.

13. The method according to claim 9, wherein obtaining a brightness of the ornament chain to be adjusted based on the current ambient brightness comprises:
obtaining a brightness of the ornament chain to be adjusted based on the current ambient brightness and a preset correspondence between ambient brightnesses and ornament chain brightnesses.

14. The method according to claim 13, wherein controlling the driving module to perform display based on the brightness of the ornament chain to be adjusted comprises:
obtaining driving signals corresponding to different types of illuminants based on the brightness of the ornament chain to be adjusted and a preset correspondence between ornament chain brightnesses and driving signals; and
sending the driving signals to the driving module for triggering the driving module to output driving currents.

15. The method according to claim 9, wherein the method further comprises:
obtaining current parameters corresponding to driving circuits in the driving module based on output currents fed back by the driving module, so as to adjust the output currents of the driving circuits in the driving module through the current parameters.
